(19) United States
(12) Patent Application Publication
(10) Pub. No.: US 2007/0102415 A1
(43) Pub. Date: May 10, 2007

(54) Heating apparatus structure

(76) Inventors: Hao-Chih Ko, Taipei County (TW); Chen-Heng Lin, Taipei (TW)

Correspondence Address: BACON & THOMAS, PLLC, 625 SLATERS LANE, FOURTH FLOOR, ALEXANDRIA, VA, 22314, US

(21) Appl. No.: 11/266,173

(22) Filed: Nov. 4, 2005

(51) Int. Cl. F27D 11/00; H05B 3/02

(52) U.S. Cl. 219/385; 219/507

(57) ABSTRACT

The present invention is to provide a heating apparatus structure, which includes a body made of a heat conduction material, two liquid tunnels parallelly disposed in the body under each of four adjacent surfaces around the body, a liquid inlet and a liquid outlet disposed respectively at one surface and connected with one of the liquid tunnels respectively, a plurality of passageways disposed at one end and another end of the body each with two ends connected to one end of two adjacent liquid tunnels respectively to form an in-and-out liquid circuit, a center tunnel parallel to other liquid tunnels disposed in the body and penetrating the body axially from one end to another end of the body for placing an electric bar to generate heat and transmit the heat to the liquid flowing in the in-and-out liquid circuit through the body.

### FIELD OF THE INVENTION

The present invention relates to a heating apparatus structure and more particularly to a heating apparatus structure to transmit heat rapidly to liquid flowing inside a body of the heating apparatus with improved characteristics.

### BACKGROUND OF THE INVENTION

The inventor filed a heat transfer apparatus on Jul. 7, 2004, in Taiwan and granted with a patent certificate of number M272955 on Aug. 11, 2005. The characteristics disclosed in this patent is to resolve problems of a conventional heat transfer apparatus structure with a copper pipe winding around a surface of a hollow sink thereof. Since the contact area between the copper pipe and the hollow sink is small, refrigerant in the copper pipe needs to circulate many times to reduce the temperature of the sink to an expected temperature. By this way, it will spend much time and waste electric power of a compressor connected with the copper pipe. With respect to the above-mentioned problems, this patent of number M272955 was thus invented.

Besides, since products of the heat transfer apparatus manufactured according to the patent of number M272955 are able to resolve defects of traditional heat transfer apparatus effectively, they were then very popular in the market. However, under circumstances with more and more competitions, distinguished features and new developments of the products should be continuously designed by the manufacturers to improve functions and efficiencies thereof for achieving remarkable success in the market. That is the reason why the inventor keeps on designing a new heating apparatus structure to increase the heating effect thereof and looks forward to adding selling points on the structure of the heating apparatus and thus presenting a flawless heating product to the users.

### SUMMARY OF THE INVENTION

In view of the foregoing introduction to the prior art, based on requirements to the heating apparatus from the market and the inventor's manufacturing experiences and technology skills accumulated in the field of heat transfer apparatus, the inventor designs and develops this invention, after continuously researching, experimenting and improving the structure of a heating apparatus, to increase the heating efficiency of the heating apparatus.

An object of the present invention is to provide a structure to transmit heat generated by an electric bar rapidly to liquid flowing in a body of the heating apparatus, which includes a heat conduction body made of a heat conduction material, two liquid tunnels parallelly disposed in the body under each of the four adjacent surfaces around the body, a liquid inlet and a liquid outlet disposed respectively at one surface and connected with one of the liquid tunnels respectively, a plurality of passageways disposed at one end and another end of the body each with two ends connected to one end of two adjacent liquid tunnels respectively to form an in-and-out liquid circuit, a center tunnel parallel to other liquid tunnels disposed in the body and penetrating the body axially from one end to another end of the body, and a cover and another cover provided to tightly cover said one end of the body and another end of the body respectively, wherein an aperture corresponding to the center tunnel is disposed on the cover, an electric bar is installed in the center tunnel through the aperture, and a inlet pipe and a outlet pipe are respectively connected to the liquid inlet and the liquid outlet to let the liquid enter from the inlet pipe to flow in order through the liquid tunnels and passageways and flow out from the outlet pipe.

Another object of the present invention is to provide a overheating protection element disposed at one surface of the body with one end connected with the electric bar through an electric wire in order to prevent the electric bar from causing the superheating danger, and to provide a warm kept bubble sponge to wrap the surfaces around the body to avoid heat from dissipating to the outside.

The above and other objects, features and advantages of the present invention will become apparent from the following detailed description taken with the accompanying drawings.

### BRIEF DESCRIPTION OF THE DRAWINGS

FIG. 1 is a perspective view of a body of a heating apparatus structure of the present invention;

FIG. 2 is a partially sectional view of FIG. 1;

FIG. 3 is another perspective view of the body of the heating apparatus structure of the present invention;

FIG. 4 is a perspective view of the heating apparatus.

### DETAILED DESCRIPTION OF THE PREFERRED EMBODIMENTS

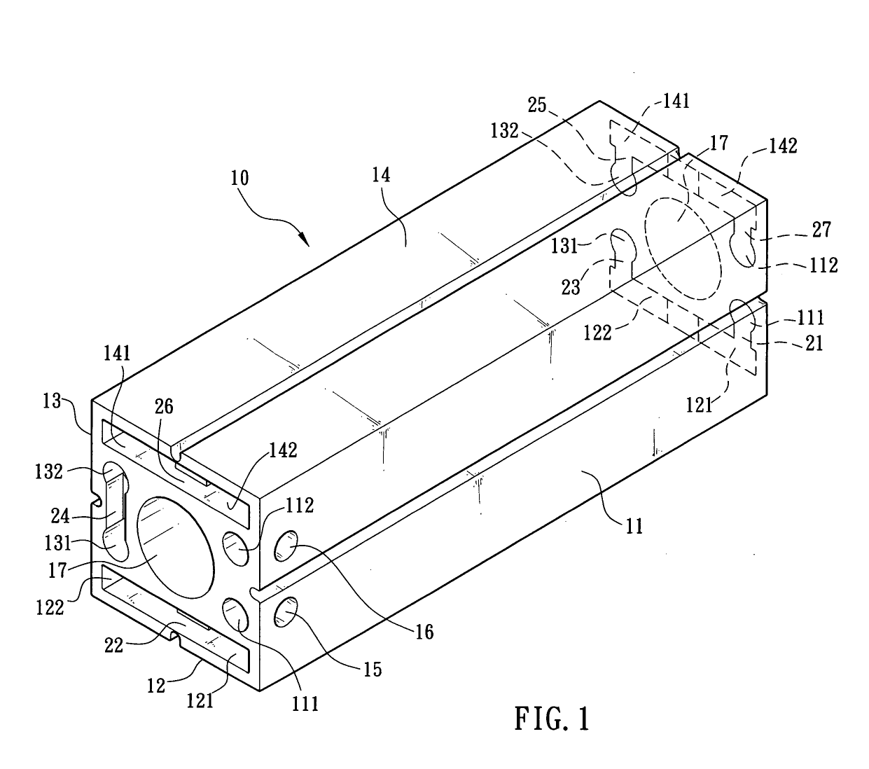

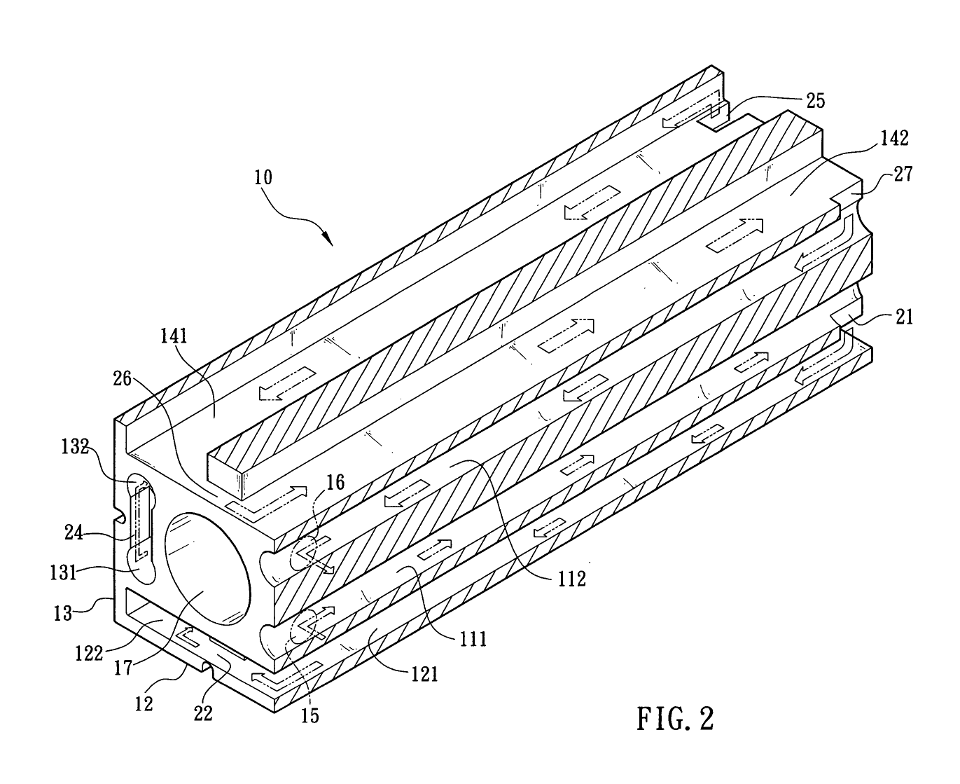

The present invention relates to a heating apparatus structure as shown in FIG. 1 and FIG. 2. The structure includes a body 10 made of a heat conduction material and having a first liquid tunnel 111, a second liquid tunnel 121, a third liquid tunnel 122, a fourth liquid tunnel 131, a fifth liquid tunnel 132, a sixth liquid tunnel 141, a seventh liquid tunnel 142 and a eighth liquid tunnel 112 parallelly disposed inside the body 10 under a first surfaces 11, a second surface 12, a third surface 13 and a fourth surface 14 thereof, where a liquid inlet 15 and a liquid outlet 16 are disposed on the first surface 11 adjacent to one end thereof, the liquid inlet 15 connects with the first liquid tunnel 111 and the liquid outlet 112 connects with the eighth liquid tunnel 112.

With reference to FIG. 1 and FIG. 2, a first passageway 21, a third passageway 23, a fifth passageway 25 and a seventh passageway 27 are disposed at one end of the body 10 away from the liquid inlet 15 and the liquid outlet 16, while a second passageway 22, a fourth passageway 24 and a sixth passageway 26 are disposed at another end of the body 10, wherein two ends of the first passageway 21 connect with one end of the first liquid tunnel 111 and one end of the second liquid tunnel 121 respectively, two ends of the second passageway 22 connect with another end of the second liquid tunnel 121 and one end of the third liquid tunnel 122 respectively, two ends of the third passageway 23 connect with another end of the third liquid tunnel 122 and one end of the fourth liquid tunnel 131 respectively, two ends of the fourth passageway 24 connect with another end of the fourth liquid tunnel 131 and one end of the fifth liquid tunnel 132 respectively, two ends of the fifth passageway 25 connect with another end of the fifth liquid tunnel 132 and one end of the sixth liquid tunnel 141 respectively, two ends of the sixth passageway 26 connect with another end of the sixth liquid tunnel 141 and one end of the seventh liquid tunnel 142 respectively, and two ends of the seventh passageway 27 connect with another end of the seventh liquid tunnel 142 and one end of the eighth liquid tunnel 112 respectively. By utilizing all the passageways to connect all the liquid tunnels, an in-and-out liquid circuit is thus formed inside the body 10.

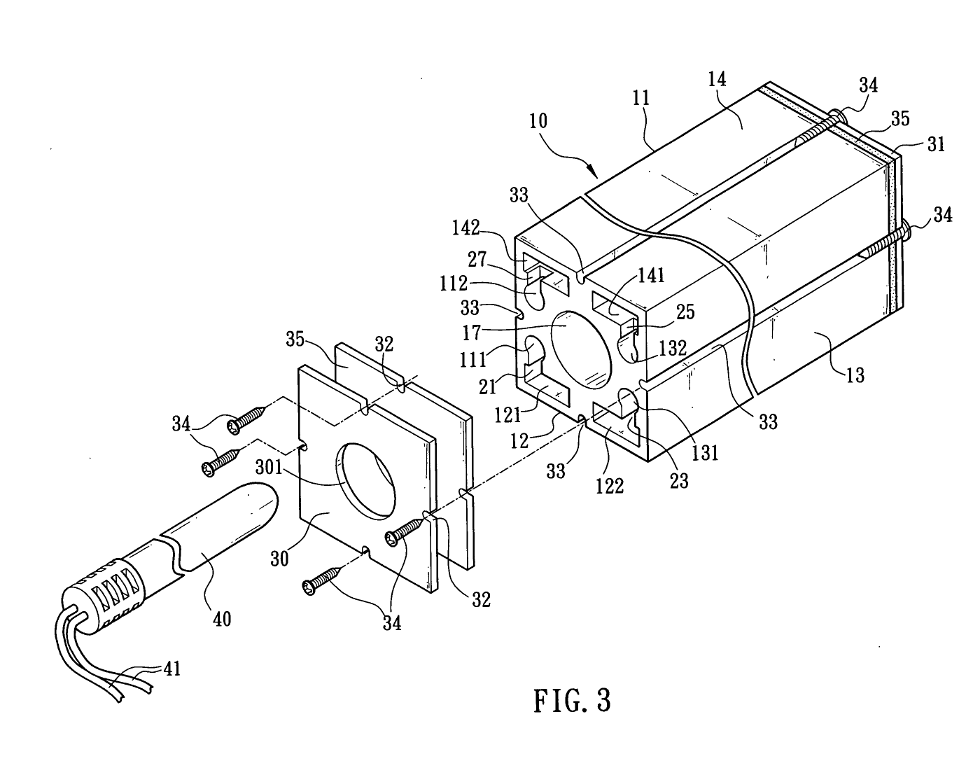

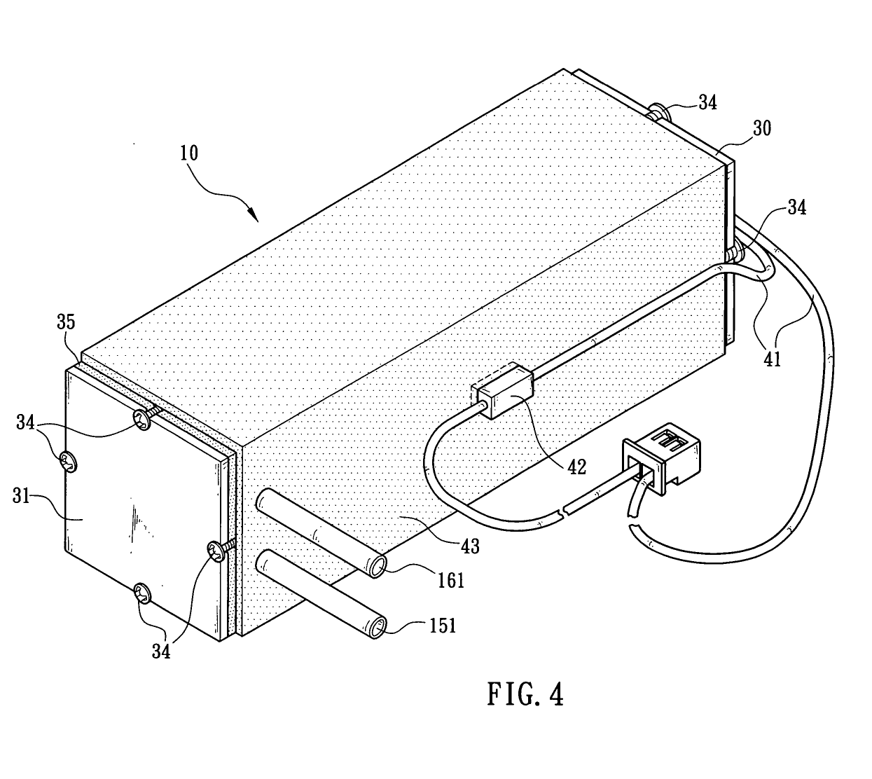

With reference to FIG. 1 and FIG. 3, a center tunnel 17 parallel to other liquid tunnels is disposed in the body 10, which penetrates the body 10 axially from one end to another end thereof. One cover 30 and another cover 31 are provided and fixed at said one end and another end of the body 10 to tightly cover both ends of the body 10 as shown in FIG. 3, wherein an aperture 301 corresponding to the center tunnel 17 is disposed on the cover 30, an electric bar 40 is installed inside the center tunnel 17 through the aperture 301. As referring to FIG. 1 and FIG. 4, a inlet pipe 151 and a outlet pipe 161 are connected respectively to the liquid inlet 15 and the liquid outlet 16, enabling liquid (such as water) to enter the inlet pipe 151 and flow in order through the first liquid tunnel 111, the first passageway 21, the second liquid tunnel 121, the second passageway 22, the third liquid tunnel 122, the third passageway 23, the fourth liquid tunnel 131, the fourth passageway 24, the fifth liquid tunnel 132, the fifth passageway 25, the sixth liquid tunnel 141, the sixth passageway 26, the seventh liquid tunnel 142, the seventh passageway 27, the eighth liquid tunnel 112, and finally flow out from the outlet pipe as shown in FIGS. 1, 2, 3 and 4. During the process of the liquid flowing through the in-and-out liquid circuit formed inside the body 10 and beneath the first surface 11, the second surface 12, the third surface 13 and the fourth surface 14, the liquid is capable of absorbing heat generated by the electric bar 40 inside the center tunnel 17 through the characteristic of thermal conductivity of the body 10 and rapidly raising its temperature to an expected temperature.

In the present invention, in order to rapidly and uniformly transmit the heat generated by the electric bar 40 to the body 10, the center tunnel 17 and the corresponding aperture 301 should be disposed at the center of the body 10 along the axis between the two ends thereof.

With reference to FIG. 3, at least a perforation 32 is disposed on each side of said one cover 30 and another cover 31, an equal number of tap holes 33 are disposed at the body 10 corresponding to the perforations 32, and at least one screw 34 is used for threading through the perforations 32 to screw the tap holes 33 and making said one cover 30 and another cover 31 to respectively and tightly cover said one end and another end of the body 10 and seal the ends of the liquid tunnels.

With reference to FIG. 3 and FIG. 4, in order to prevent the liquid in the liquid tunnels from leaking out, silica gel washers 35 are respectively disposed at between said one cover 31 and said one end of the body 10, and between said another cover 31 and said another end of the body 10, to tightly seal the ends of the liquid tunnels. And, in order to prevent a superheating danger caused by the electric bar 40, an overheating protection element 42 such as a superheat spring slice is disposed at one surface of the body 10 with one end connected with the electric bar 40 through an electric wire 41. In addition, a warm kept bubble sponge 43 is provided to wrap around the surfaces of the body 10, as shown in FIG. 4, to keep the temperature of the body 10 from dissipating to the outside.

Furthermore, since the body 10 is made of aluminum by extrusion to form the structure thereof in one unity, it is therefore easily achieving the advantages of lowering the manufacturing cost, reducing volume of the body 10 and effectively improving heat transmission rate of the heating apparatus.

Summing up the above, it is apparent that the structure of the heating apparatus according to this invention is very simple and, through the liquid flowing in the in-and-out liquid circuit and the temperature generated by the electric bar 40 inside the body 10, the heat absorbed by the body 10 can then be rapidly transmitted to the liquid, making the heating apparatus to have a superior heat transmitting efficiency.

While the invention herein disclosed has been described by means of specific embodiments, numerous modifications and variations could be made thereto by those skilled in the art without departing from the scope and spirit of the invention set forth in the claims.

What is claimed is:

1. A heating apparatus structure, comprising:
a body made of a heat conduction material, having a first liquid tunnel, a second liquid tunnel, a third liquid tunnel, a fourth liquid tunnel, a fifth liquid tunnel, a sixth liquid tunnel, a seventh liquid tunnel and a eighth liquid tunnel parallelly disposed inside the body under four adjacent surfaces around the body, where a liquid inlet and a liquid outlet are disposed on the first surface adjacent to one end thereof, the liquid inlet connects with the first liquid tunnel and the liquid outlet connects with the eighth liquid tunnel; a first passageway, a third passageway, a fifth passageway and a seventh passageway disposed at one end of the body away from the liquid inlet and the liquid outlet while a second passageway, a fourth passageway and a sixth passageway disposed at another end of the body, wherein two ends of the first passageway connect with one end of the first liquid tunnel and one end of the second liquid tunnel respectively, two ends of the second passageway connect with another end of the second liquid tunnel and one end of the third liquid tunnel respectively, two ends of the third passageway connect with another end of the third liquid tunnel and one end of the fourth liquid tunnel respectively, two ends of the fourth passageway connect with another end of the fourth liquid tunnel and one end of the fifth liquid tunnel respectively, two ends of the fifth passageway connect with another end of the fifth liquid tunnel and one end of the sixth liquid tunnel respectively, two ends of the sixth passageway connect with another end of the sixth liquid tunnel and one end of the seventh liquid tunnel respectively, and two ends of the seventh passageway connect with another end of the seventh liquid tunnel and one end of the eighth liquid tunnel respectively to form an in-and-out liquid circuit inside the body;
a center tunnel parallel to other liquid tunnels disposed in the body, which penetrates the body axially from one end to another end thereof;
two covers provided to tightly cover the two ends of the body respectively, wherein an aperture corresponding to the center tunnel is disposed on one of the two covers;
an electric bar installed inside the center tunnel through the aperture for generating heat;
a inlet pipe and a outlet pipe connected respectively to the liquid inlet and the liquid outlet.

2. The method of claim 1 further including an overheating protection element disposed at one surface of the body with one end connected with the electric bar through an electric wire.

3. The method of claim 1, wherein at least a perforation is disposed on each side of said one cover and another cover, an equal number of tap holes are disposed at the body corresponding to the perforations, and at least one screw is disposed for threading through the perforations to screw the tap holes and making said two covers to respectively and tightly cover said two ends of the body and seal the ends of the liquid tunnels.

4. The method of claim 1 further including silica gel washers each disposed at between said one cover and said one end of the body and between said another cover and said another end of the body respectively

5. The method of claim 1 further including a warm kept bubble sponge wrapping around the surfaces of the body.
